(19) United States
(12) Patent Application Publication
(10) Pub. No.: US 2012/0004788 A1
(43) Pub. Date: Jan. 5, 2012

(54) HEATING BLANKET WITH CONTROL CIRCUIT AND SAFETY WIRE

(76) Inventor: Barry P. Keane, Seneca, SC (US)

(21) Appl. No.: 13/044,395

(22) Filed: Mar. 9, 2011

Related U.S. Application Data
(60) Provisional application No. 61/312,518, filed on Mar. 10, 2010.

(51) Int. Cl. H05B 1/00; G05D 23/24; H05B 3/06

(52) U.S. Cl. 700/300; 219/212

(57) ABSTRACT

A safety wire for use in a heating blanket has a core, a heating wire wrapped around the core, and a guard wire spaced apart from the heating wire. In a normal mode of operation, the guard wire is not physically or electrically coupled to the heating wire, but in a breakdown mode of operation, the guard wire is electrically coupled to the heating wire. A TRIAC may be operatively coupled to the heating wire so that when the guard wire is electrically coupled to the heating wire, the TRAIC is turned on so that current flows from the heating wire to a fuse.

### CLAIM OF PRIORITY

This application claims priority to U.S. Provisional Patent Application Ser. No. 61/312,518, filed Mar. 10, 2010, the entire disclosure of which is incorporated by reference herein.

### FIELD OF THE INVENTION

The present invention relates generally to heating blankets. More particularly, the present invention relates to a heating blanket protection circuit for use with guard conductors.

### BACKGROUND

The present invention recognizes and addresses disadvantages of prior art constructions and methods of heating blankets, and it is an object of the present invention to provide an improved heating blanket protection circuit for use with guard conductors.

Various combinations and sub-combinations of the disclosed elements, as well as methods of utilizing same, which are discussed in detail below, provide other objects, features and aspects of the present invention.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a schematic diagram of a control circuit for prior art heating blankets;

FIG. 2 is a schematic diagram of a new control circuit in accordance with one embodiment of the present invention for use with prior art heating blankets;

FIG. 3 is a top view of a heating blanket wire having a guard in accordance with one embodiment of the present invention;

FIG. 4 is a top view of termination connectors in accordance with one embodiment of the present invention for connecting the heating blanket wire of FIG. 1 to a control circuit;

FIG. 5 is a top plan view of the termination connector of FIG. 4 in use on the heating blanket wire of FIG. 3;

FIG. 6 is a top view of a heating blanket wire having a guard in accordance with one embodiment of the present invention;

FIG. 7 is a top view of a heating blanket wire having a guard in accordance with one embodiment of the present invention;

FIG. 8 is a schematic view of a protection circuit for use with any one of the heating blanket wires disclosed in FIGS. 3, 6 and 7; and

FIG. 9 is a schematic diagram of a control circuit for use with the protection circuit of FIG. 8 and with any one of the heating blanket wires disclosed in FIGS. 3, 6 and 7.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations. Additional aspects and advantages of the invention will be set forth in part in the description that follows and, in part, will be obvious from the description, or may be learned by practice of the invention.

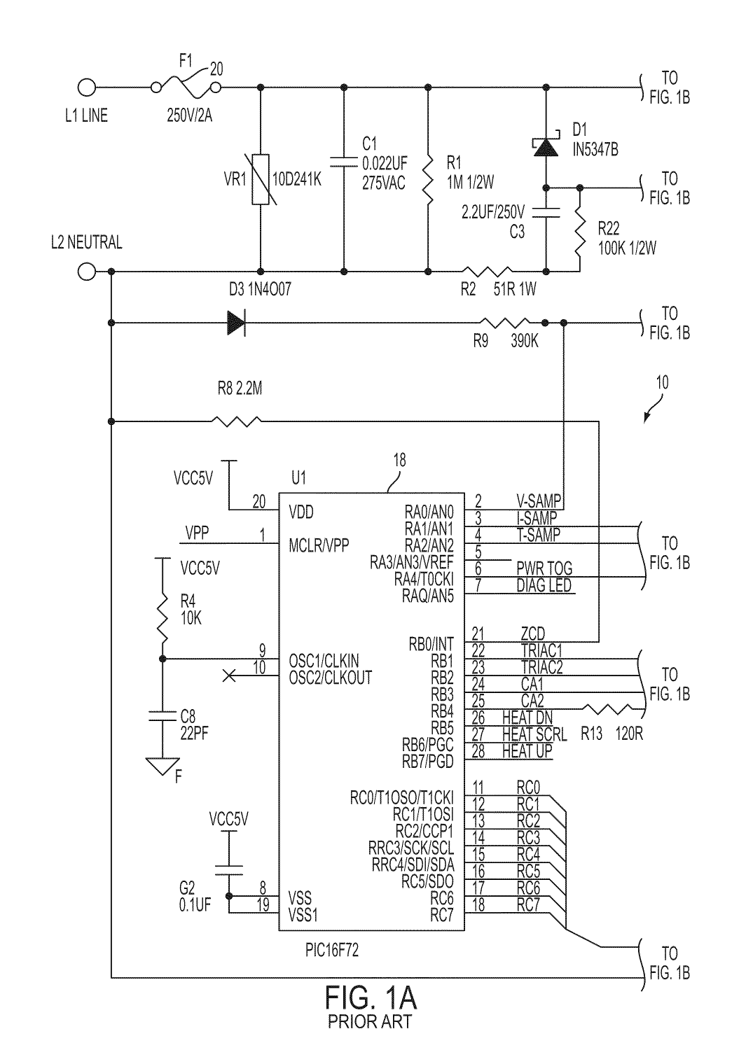

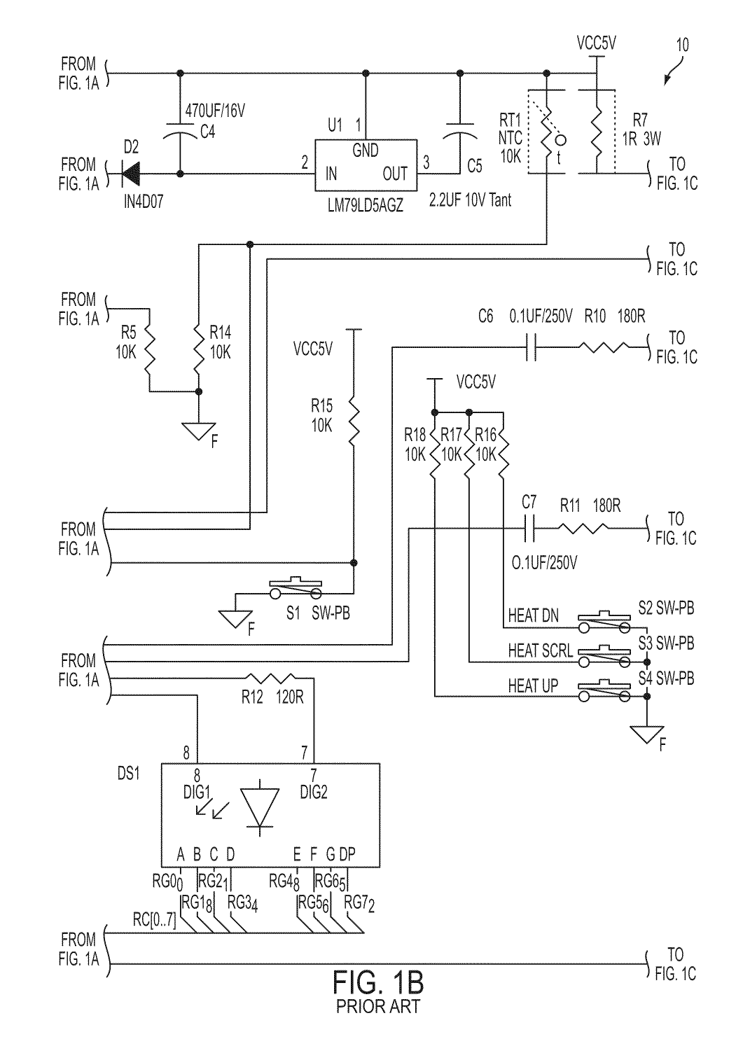

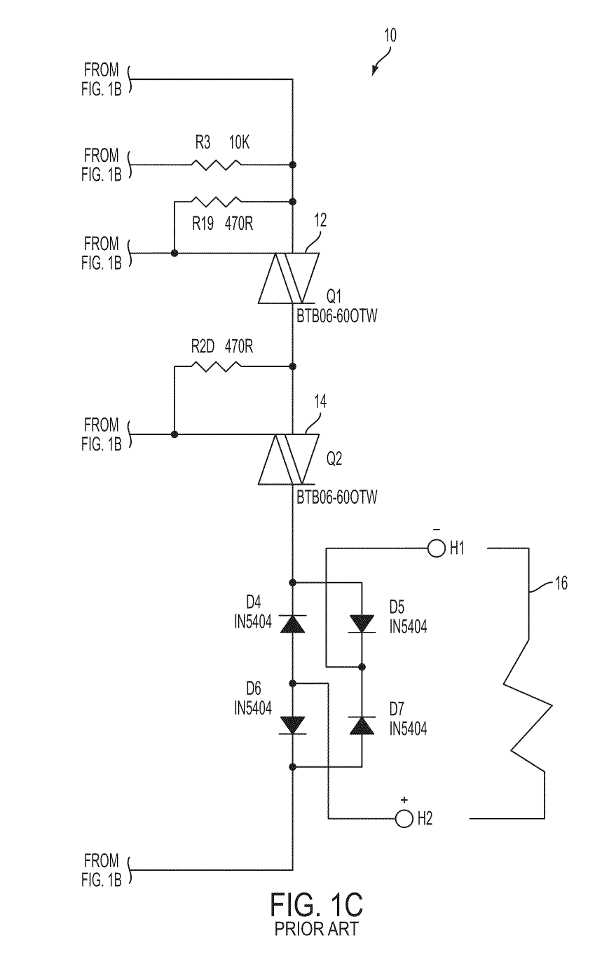

Referring to FIG. 1, a prior art control circuit 10 is shown having an electric blanket heating circuit 16 connected across terminals H1 and H2. Power is connected to control circuit 10 across terminals L1 and L2. A fuse 20 is operatively coupled to L1 and two Triodes for Alternating Current (TRIACS) 12 and 14. The gate of each TRIAC 12 and 14 is operatively coupled to a CPU 18. The use of two TRIACS 12 and 14 is to guard against a single TRIAC failing permanently by short and causing overheating to occur. In the dual TRIAC configuration, both TRIACs would have to fail for overheating to occur, thus the chance of this happening is greatly reduced. However, it is theoretically possible that a hardware failure in CPU 18 could result in signals where the TRIACS could both turn on. For example, a failure that would connect the CPU 18 to L2 could theoretically result in unintended signals to the gates of TRIACS 12 and 14 resulting in sufficient gate currents to turn on both TRIACS. If this condition were allowed to persist, overheating of heating blanket 16 may occur.

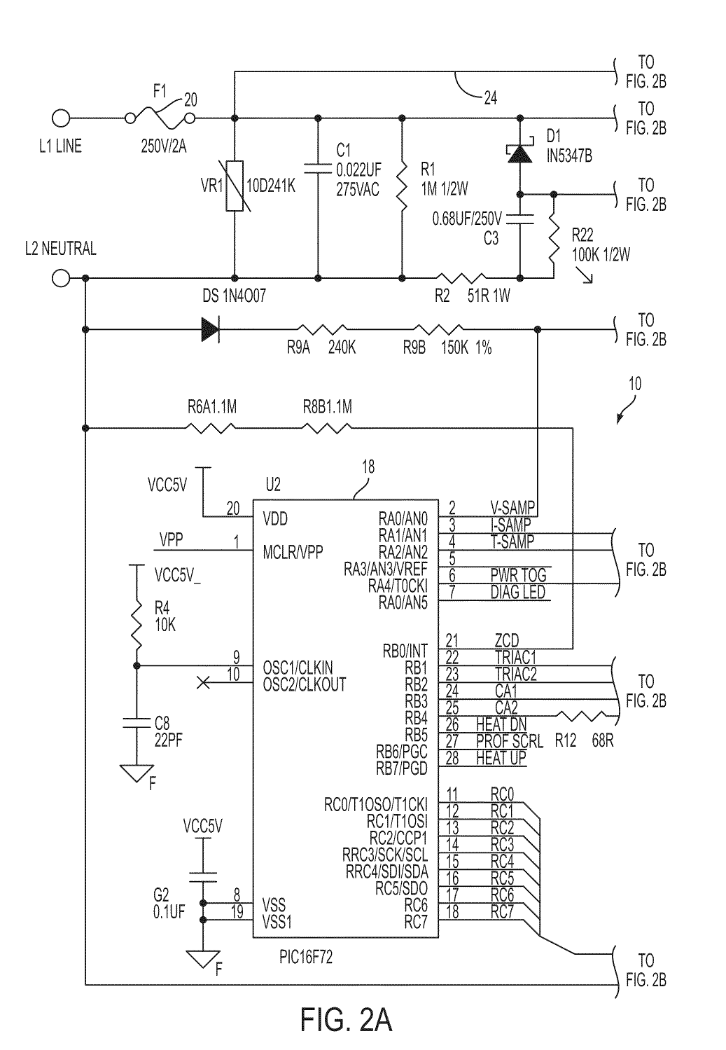

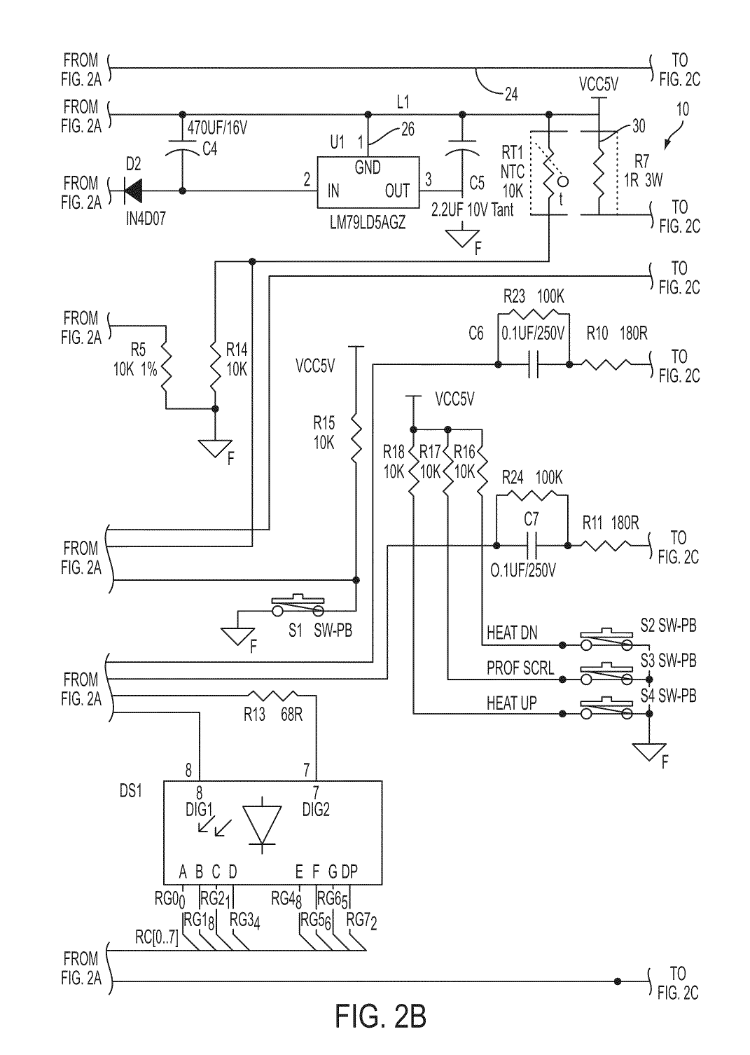

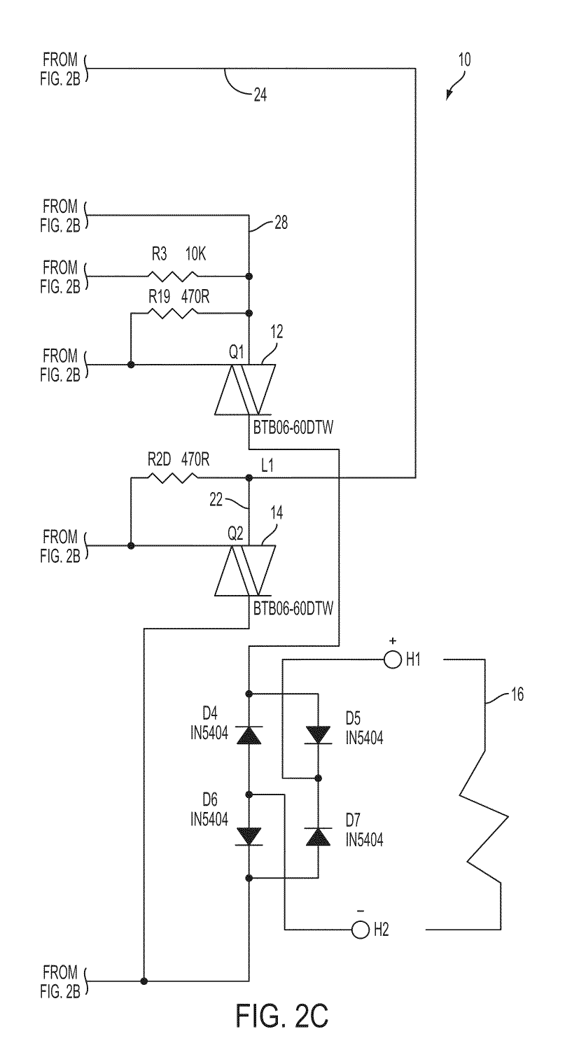

Referring to FIG. 2, with new control circuit 10, TRIAC 14 is connected so as to open the fuse if the TRIAC is ever turned on. If the theoretical failure described above occurs, both TRIACs would be turned on, and the fuse would therefore open before overheating could occur. In addition, CPU 18 monitors current via voltage 28 across current sensing resistor 30. Also, if TRIAC 12 shorts, U1 can determine that current is flowing when TRIAC 12 should be off. In this case, U1 commands TRIAC 14 to turn on, which in turn causes fuse 20 to open. Thus, the concept of guarding against the shorting of TRIAC 12 is still intact, and the new control circuit configuration prevents unintended operation of heating blanket 16 if TRIAC 12 shorts.

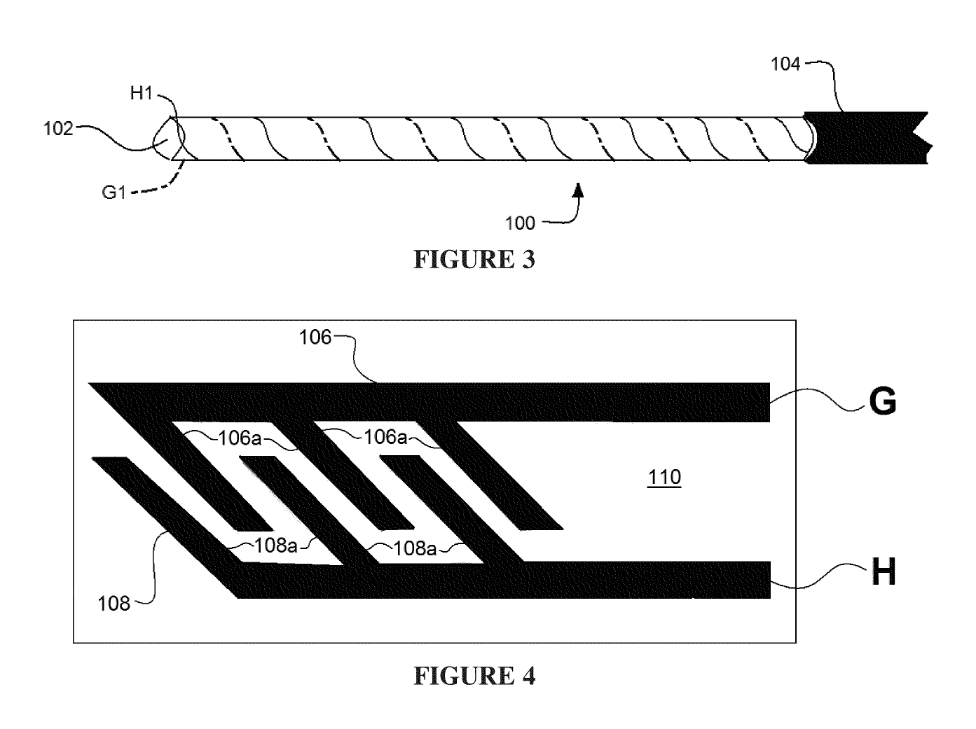

Referring to FIG. 3, a new safety wire is shown for use in a heating blanket.

The safety wire has an inner layer 102 made from a polyester core, a middle layer having two conductors: the first conductor H₁ formed from heater alloy (Percon-19) and the second conductor G₁ formed from guard alloy (304 stainless steel) and an outer layer 104 formed from PVC insulation. The conductors are wound in a helical fashion and do not connect to one another electrically or physically in normal operation. The spacing between wires H₁ and G₁ may vary depending on the voltage across the heating wire of the blanket and the most advantageous manufacturing practices. In all cases, the spacing should be sufficient to prevent any electrical connection between heating wire H₁ and guard wire G₁. Provision is made at the ends of the assembly for connection to the individual windings. Current through the heater winding produces heat for the blanket.

The guard winding is used to sense leakage current or breakdown between the heater winding H₁ and the guard winding G₁. When overheating occurs, the outer coating will melt, allowing migration of the wires so that the heating wire comes into electrical contact with the guard wire or sufficiently close for dielectric breakdown. The guard winding does not vary predictably with temperature, and no attempt is made to measure the resistance of or the voltage across the guard winding. The guard wire requires connection at one point, and thus the wire from the controller to the blanket comprises three conductors, not four as required by prior art designs. A three wire design is more flexible and is lower in cost than other safety wire designs. It should be noted that for additional reliability, the guard wire may be connected at both ends.

Referring to FIG. 4, a printed circuit board connector 110 is shown having two main conductors 106 and 108. Main conductor 106 defines three trace conductors 106a that are formed at an angle with respect to main conductor 106. Similarly, main conductor 108 also defines three trace conductors 108a that are formed at an angle with respect to main conductor 108. The angle of trace conductors 106a with respect to main conductor 106 is complementary to the helical angle of guard wire G₁. Moreover, the angle of trace conductors 108a with respect to main conductor 108 is also complementary to the helical angle of heating wire H₁.

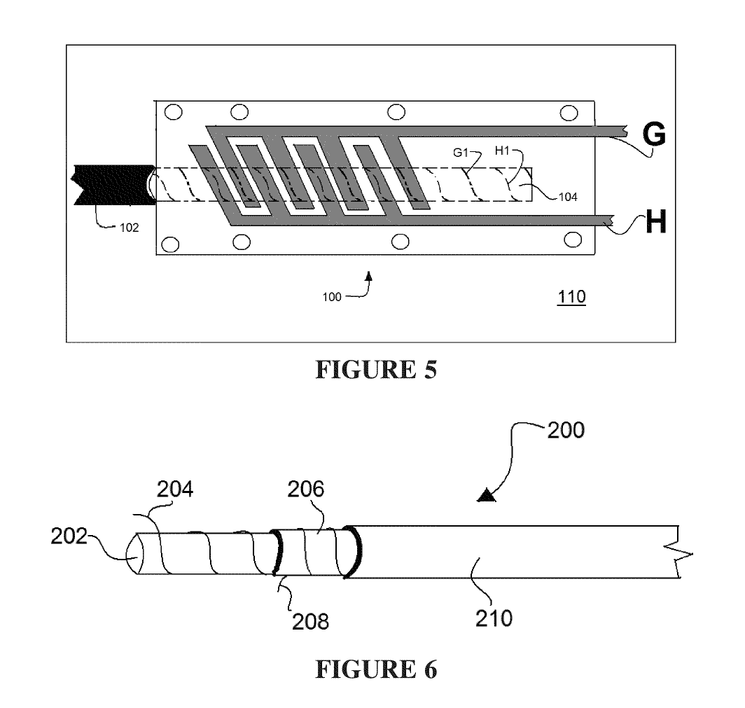

Referring to FIG. 5, safety wire 100 is shown in one preferred embodiment mounted to printed circuit board connector 110 by clamping the stripped wire 100 to trace conductors 106a and 108a with a bolt-down fixture that holds the wire in place. In the embodiment shown, the trace conductors are shown in a flat top view. The angle and spacing of the trace conductors match the helical angle and spacing of the wires. After stripping the outer insulation from the wire, the ends must be trimmed and oriented so as to make proper contact with the respective traces conductors. The printed circuit board connector will hold the wire in place and ensure proper electrical contact. The same termination should be made at both ends of heat wire H₁ and guard wire G₁. Connecting at both ends gives protection even if a break were to occur somewhere along the guard wire within the blanket since the entire length of the guard will still connect to the gate of TRIAC 14.

Referring to FIG. 6, in yet another preferred embodiment a safety wire 200 is shown having an inner layer 202 formed from a polyester core, a second layer 204 of heater alloy (Percon-19), a third layer 206 of PVC insulation, a fourth layer 208 of guard alloy (304 stainless steel) and a fifth layer 210 of PVC insulation. Guard winding 208 does not measure temperature but detects leakage current from heater winding 204 caused by guard wire 208 and heater wire 204 coming close together as a result of overheating or physical damage. The guard wire requires connection at one point, so the wire from the controller to the blanket comprises only three conductors, not four as required by prior art designs to reduce cost. In one preferred embodiment, the helical windings are set at ten windings per inch.

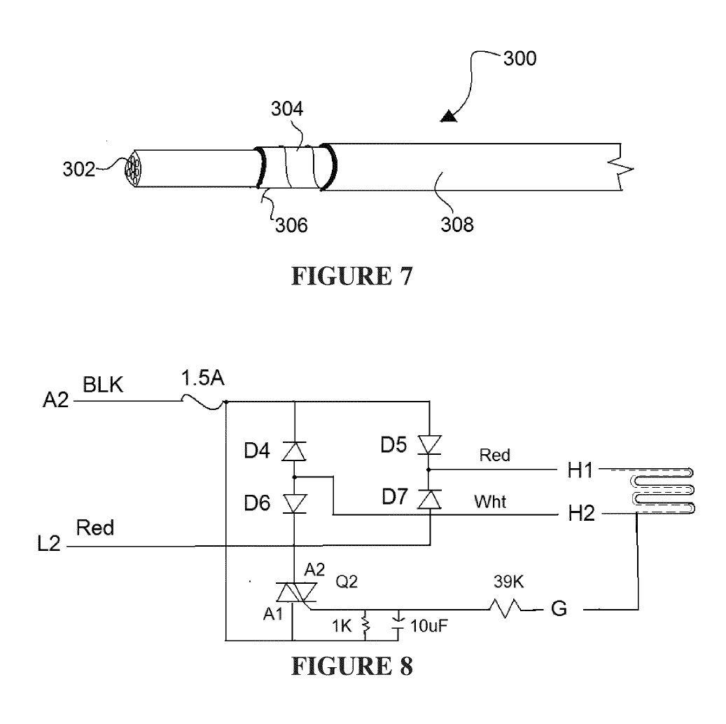

Referring to FIG. 7, in still another preferred embodiment a safety wire 300 has an inner layer 302 formed from a stranded guard conductor (304 stainless steel), a second layer 304 of PVC insulation material, a third layer 306 formed from a helical winding of heater alloy (Percon-19) and a fourth layer 308 formed of PVC insulation. With respect to inner layer 302, the guard wire does not need to vary predictably with temperature, and the heating wire from the controller to the blanket comprises three conductors, not four as required by prior art designs.

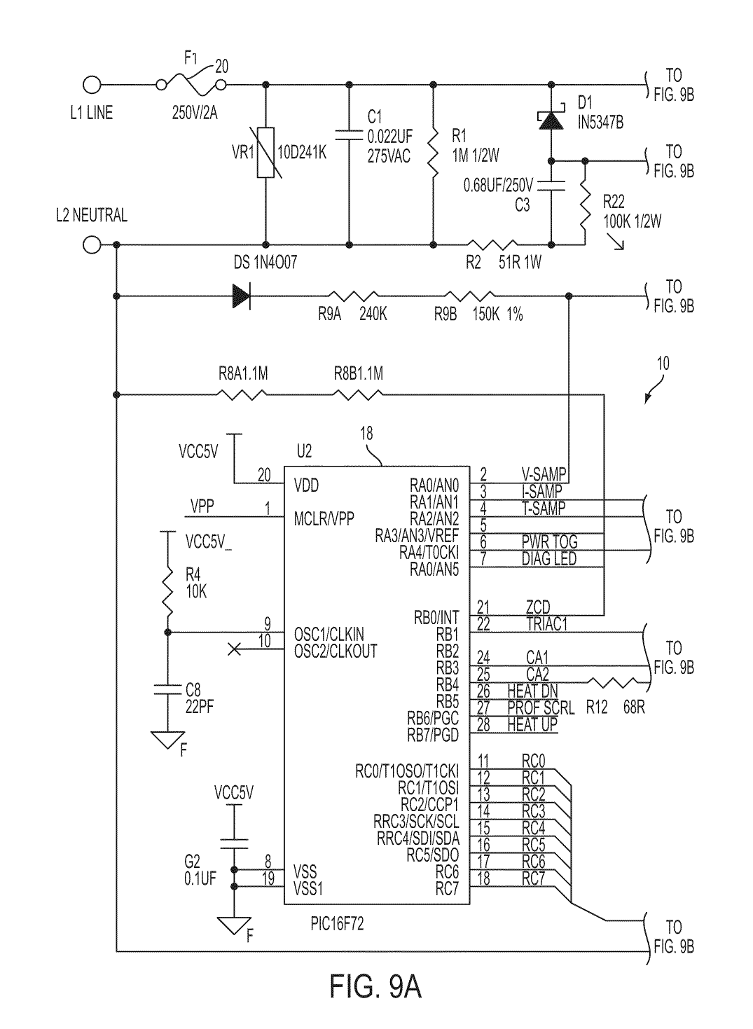

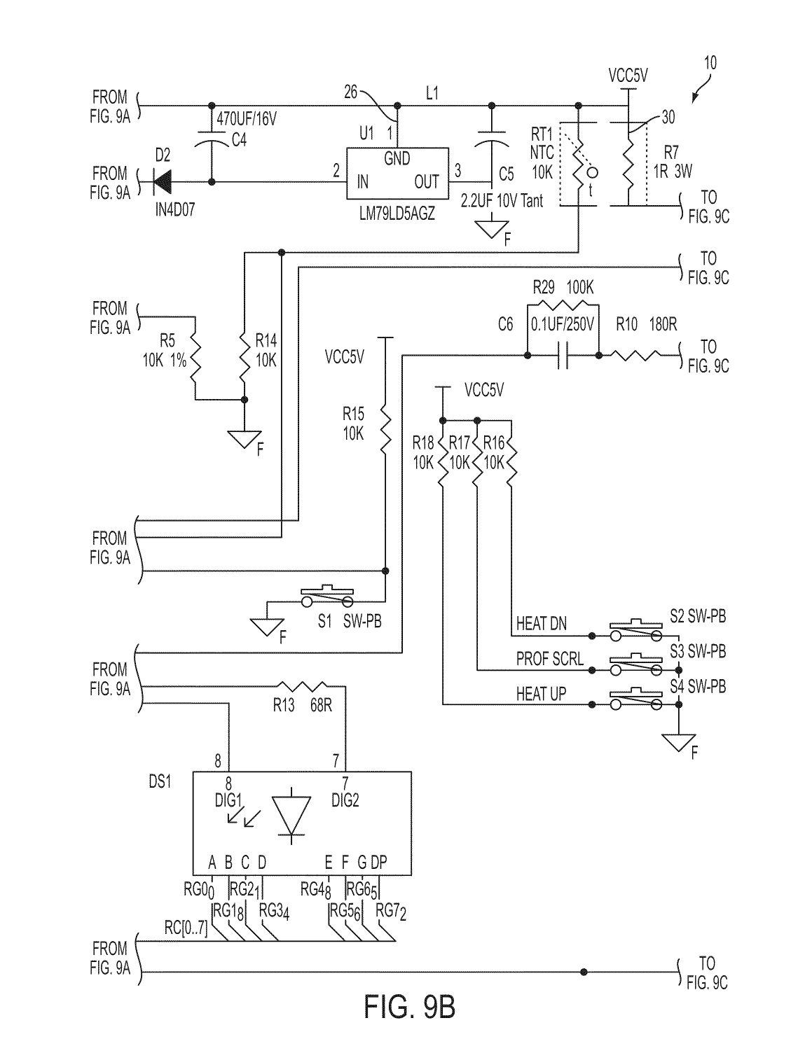

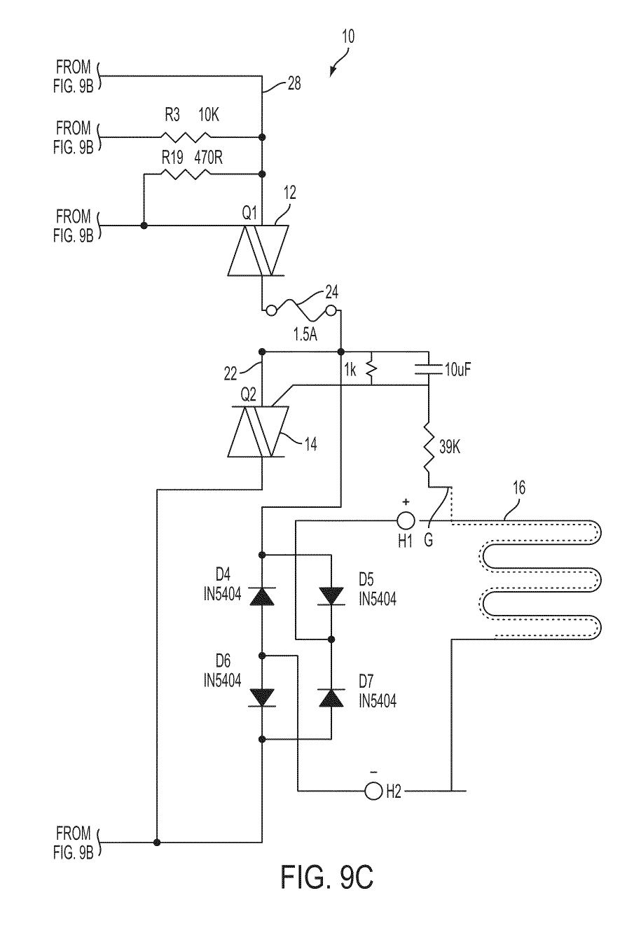

As described with reference to FIGS. 3, 6 and 7, the safety wire can have various constructions, but common to all constructions is a safety shield or guard wire. With reference to FIG. 8, a protection circuit is shown for use with the safety wires of FIGS. 3, 6 and 7. This protection circuit can be physically located either on the same printed circuit board as the rest of the control circuit (FIG. 9), or it can be located on a separate printed circuit board within the blanket 16. Locating the protection circuit (FIG. 8) within the blanket 16 has the added advantages of only requiring a two-wire connecting cord and protection against tampering in the form of connecting the blanket directly to AC power. A safety TRIAC Q2 is triggered if significant leakage current reaches the guard wire from the heating wire because of a breakdown in the safety wire anywhere along the safety wire. Using diodes D4-D7 to “switch ends” during each half cycle ensures that there is always sufficient potential difference between the heating wire and the guard wire at all points along the length of the safety wire. Without diodes D4-D7, the closer the breakdown locus to L1 end (FIG. 9), the less chance of detection, and a breakdown at the L end would not be detectable. For example, using D4-D7, consider the following breakdown locations:

1. Breakdown at H1 end of heater: Maximum voltage potential will occur when L1 (line) is most negative with respect to L2 (neutral). In this case, nearly the full peak line voltage appears on the guard, the guard being positive with respect to L1. A1 of the triac (Q2) is connected to the fused side of the line (L1), so if its gate is electrically connected to the guard via D7, this will turn on Q2 as soon as the trigger conditions of the specific triac are met. This will open the fuse and permanently disconnect the heater from the power source.

2. Breakdown at H2 end of heater: Maximum voltage potential will occur when L1 is most positive with respect to L2. Nearly the full line voltage appears on the guard via D6, the guard in this case being negative with respect to L1 . Again, the Q2 will turn on once trigger conditions are met and open the fuse.

3. Worst case, midpoint of heater: During negative half-cycles, the guard wire will be made positive with respect to L1 by an applied potential of approximately ½ the peak line voltage. During positive half-cycles, the guard will be negative by ½ the peak line voltage.

While one or more preferred embodiments of the invention have been described above, it should be understood that any and all equivalent realizations of the present invention are included within the scope and spirit thereof. The embodiments depicted are presented by way of example and are not intended as limitations upon the present invention. Thus, those of ordinary skill in this art should understand that the present invention is not limited to these embodiments since modifications can be made. Therefore, it is contemplated that any and all such embodiments are included in the present invention as may fall within the scope and spirit of the invention.

What is claimed:

1. A safety wire for use in a heating blanket, said safety wire comprising:
a. a core;
b. a heating wire wrapped around said core; and
c. a guard wire spaced apart from said heating wire, wherein
said heating wire is configured to carry a current,
in said normal mode of operation said guard wire is not physically or electrically coupled to said heating wire, and
in a breakdown mode of operation said guard wire is electrically coupled to said heating wire.

2. The safety wire of claim 1, wherein said heating wire and said guard wire are helically wrapped around said core so that said heating wire is longitudinally spaced apart from said guard wire along the length of said core.

3. The safety wire of claim 2, further comprising a cover layer wherein said heating wire and said guard wire are intermediate said core and said cover layer.

4. The safety wire of claim 1, further comprising a non-electric layer intermediate said heating wire and said guard wire, wherein said guard wire is wrapped around said non-electric layer.

5. The safety wire of claim 4, further comprising an outer layer that covers said guard wire.

6. The safety wire of claim 4, wherein said heating wire is helically wrapped around said core and said guard wire is helically wrapped around said non-electric layer.

7. The safety wire of claim 1, wherein said guard wire is formed inside said core, and said heating wire is helically wrapped around said core.

8. The safety wire of claim 7, further comprising a outer layer that covers said heating wire.

9. The safety wire of claim 7, wherein said guard wire is formed from a bundle of wires.

10. The safety wire of claim 1, further comprising a safety circuit comprising a TRIAC having a gate, wherein said gate is coupled to said guard wire.

11. The safety wire of claim 10, wherein said TRIAC is operatively coupled to said heating wire so that when said guard wire is electrically coupled to said heating wire, said TRIAC is turned on so that current flows from said heating wire through said TRIAC to a fuse, thereby opening the fuse to prevent further electric current from passing through said heating wire.

12. A control circuit for use with a heating blanket having a heating wire, said control circuit comprising:
a. a TRIAC having a gate;
b. a CPU operatively couple to said TRIAC gate;
c. a first connector coupled to a power source through a fuse; and
d. a second connector coupled to a neutral source,
wherein when said voltage on said gate is above a predetermined threshold, said TRIAC turns on, allowing current to flow through said TRIAC to said fuse and thereby causing said fuse to open to prevent the heating blanket from overheating.

13. The control circuit of claim 12, wherein said TRIAC gate is also coupled to a guard wire in said heating blanket.

14. The control circuit of claim 13, wherein when a breakdown occurs in said heating blanket, a voltage from a heating wire is coupled to said guard wire so that a voltage on said TRIAC gate is above said predetermined threshold so that said TRIAC turns on.
